(19) United States
(12) Patent Application Publication
(10) Pub. No.: US 2006/0158305 A1
(43) Pub. Date: Jul. 20, 2006

(54) Resistor paste, resistor and electronic component

(75) Inventors: Hirobumi Tanka, Chuo-ku (JP); Katsuhiko Igarashi, Chuo-ku (JP)

Correspondence Address: OLIFF & BERRIDGE, PLC, P.O. BOX 19928, ALEXANDRIA, VA, 22320, US

(73) Assignee: TDK CORPORATION, Tokyo (JP)

(21) Appl. No.: 10/563,756

(22) PCT Filed: Jul. 16, 2004
(86) PCT No.: PCT/JP04/10185

§ 371 Date: Jan. 9, 2006

(30) Foreign Application Priority Data
Jul. 18, 2003 (JP) 2003-275541

(51) Int. Cl. H01C 8/00

(52) U.S. Cl. 338/223

(57) ABSTRACT

A resistor paste comprising a glass material substantially not including lead and including 0.1 to 10 mol % of NiO, a conductive material substantially not including lead, and an organic vehicle. According to the invention, it is possible to provide a lead-free resistor paste suitable for obtaining a resistor having a small temperature characteristic of a resistance (TCR) and a small short-time overload (STOL) while maintaining a high resistance.

### TECHNICAL FIELD

The present invention relates to a resistor paste, a resistor and an electronic device.

### BACKGROUND ART

Generally, a resistor paste is mainly composed of a glass material for adjusting a resistor value and giving a bonding ability, a conductive material and an organic vehicle (a binder and a solvent) and, by printing the paste on a substrate and firing, a thick-film resistor (10 to 15 μm or so) is formed.

In many cases, resistor pastes use lead oxide based glass as the glass material and a ruthenium oxide or a compound of a ruthenium oxide and lead as the conductive material in the related art, which means lead is included in the pastes.

However, it is not preferable to use a resistor paste including lead in terms of environmental pollution, so that a variety of proposals have been made on lead-free thick-film resistor pastes (for example, refer to the patent articles 1 to 5).

Normally, thick-film resistors having a high sheet resistance of 100 kΩ/□ generally exhibit a negative value in the temperature characteristics of the resistance (TCR), so that CuO or other additive is added as a TCR adjuster to make the TCR close to “0”. A variety of proposals are made on the TCR adjuster (for example, refer to the patent articles 6 and 7).

However, these methods were for glass based pastes including lead, and when using the conventional method of adding CuO or other additive in a resistor paste formed by a lead-free conductive material and lead-free glass material, there arose a problem of deteriorating a short-time overload (STOL) of the breakdown voltage characteristic when adjusting the TCR and it was difficult to adjust the characteristic.

Patent Article 1: The Japanese Unexamined Patent Publication No. 8-253342

Patent Article 2: The Japanese Unexamined Patent Publication No. 10-224004

Patent Article 3: The Japanese Unexamined Patent Publication No. 2001-196201

Patent Article 4: The Japanese Unexamined Patent Publication No. 11-251105

Patent Article 5: The Japanese Patent No. 3019136

Patent Article 6: The Japanese Unexamined Patent Publication No. 61-67901

Patent Article 7: The Japanese Unexamined Patent Publication No. 5-242722

### DISCLOSURE OF THE INVENTION

An object of the present invention is to provide a lead-free resistor paste suitable for obtaining a resistor having a small temperature characteristic of a resistance (TCR) and a small short-time overload (STOL) while maintaining a high resistance.

Another object of the present invention is to provide a resistor having a small TCR and STOL while maintaining a high resistance and an electronic device, such as a circuit substrate, comprising the resistor.

To attain the above objects, according to the present invention, there is provided a resistor paste including a glass material substantially not including lead and including NiO, a conductive material substantially not including lead, and an organic vehicle.

According to the present invention, there is provided a resistor paste comprising a glass material substantially not including lead and including 0.1 to 10 mol % of NiO, a conductive material substantially not including lead, and an organic vehicle.

According to the present invention, there is provided a resistor comprising a glass material substantially not including lead and including NiO and a conductive material substantially not including lead. According to the present invention, there is provided a resistor comprising a glass material substantially not including lead and including 0.1 to 10 mol % of NiO and a conductive material substantially not including lead.

According to the present invention, an electronic device comprising the resistor is provided.

Preferably, a content of the glass material is 65 to 93 volume % (or 49 to 88 wt %) and a content of the conductive material is 7 to 35 volume % (or 10 to 51 wt %).

Preferably, the glass material includes

an A group including at least one kind selected from CaO, SrO, BaO and MgO,

a B group including B₂O₃,

a C group including SiO₂,

a D group including at least one of ZrO₂ and Al₂O₃, and

an E group including NiO.

Preferably, contents of the respective groups are
A group: 20 to 40 mol %,
B group: 18 to 45 mol %,
C group: 21 to 40 mol %,
D group: 10 mol % or smaller (note that 0 mol % is excluded), and
E group: 0.1 to 10 mol %.

Preferably, the glass material includes

an A group including at least one kind selected from CaO, SrO, BaO and MgO,

a B group including B₂O₃,

a C group including SiO₂, and

an E group including NiO.

Preferably, contents of the respective groups are

A group: 20 to 40 mol %,

B group: 18 to 45 mol %,

C group: 21 to 40 mol %, and

E group: 0.1 to 10 mol %.

The glass material may furthermore include an F group including at least one kind selected from ZnO, MnO, CuO, CoO, Li₂O, Na₂O, K₂O, P₂O₅, TiO₂, Bi₂O₃, V₂O₅ and Fe₂O₃. A content of the F group in this case is preferably 0 to 5 mol % (note that 0 mol % is excluded).

Preferably, the resistor paste and resistor according to the present invention includes CuO as an additive, and a content of the CuO is 0.1 to 2 volume % (or 0.1 to 6 wt %).

Preferably, the resistor paste and resistor according to the present invention include an oxide having a perovskite type crystal structure as an additive, and a content of the oxide is 0.1 to 12 volume % (or 0.1 to 20 wt %).

As the oxide having a perovskite type crystal structure, CaTiO₃ is preferable.

Preferably, the conductive material includes RuO₂ or a composite oxide of Ru.

In the present invention, “substantially not including lead” means lead in an amount of exceeding an impurity level is not included and lead in an amount of an impurity level (for example, a content in the glass material or the conductive material is not more than 0.05 volume %) may be included. Lead is sometimes contained at an infinitesimal level as an inevitable impurity.

In the present invention, a resistor paste is formed by adding a lead-free glass material including NiO to a lead-free conductive material. Therefore, a resistor formed by using the same has a small absolute value of TCR (for example, within ±400 ppm/° C., preferably within ±200 ppm/° C., and more preferably within ±100 ppm/° C.) and, moreover, the STOL can be suppressed small (for example, ±7% or smaller, preferably ±5% or smaller) while maintaining a high resistance (for example, 100 kΩ/□ or higher, and preferably 1 MΩ/□ or higher). Namely, a resistor formed by using the resistor paste of the present invention is capable of keeping preferable characteristics even when a temperature and an application voltage are changed in the use environment, so that it is highly beneficial.

Note that a resistor paste obtained by adding NiO as an additive to a lead-free conductive material and a lead-free glass material has been proposed previously (the Japanese Patent Application No. 2001-390243). This resistor paste also gives an equivalent effect to that of the present invention, however, the NiO content in the resistor has to be relatively large comparing with that in the present invention. A superior point of the present invention to the prior application is that the equivalent effect can be obtained even when the NiO content in the resistor is small (specifically, for example, even in the case of about ⅛ of the content in the prior application).

The resistor according to the present invention can be also applied to an electrode part of a capacitor and an inductor other than a single-layer or multilayer circuit substrate. The resistor is formed to be a thick film (for example, 10 to 15 μm or so).

The electronic device according to the present invention is not particularly limited and a circuit substrate, capacitor, inductor, chip resistor and isolator, etc. may be mentioned.

### BEST MODE FOR CARRYING OUT THE INVENTION

Resistor Paste

A resistor paste according to the present invention includes a glass material substantially not including lead and including NiO, a conductive material substantially not including lead, and an organic vehicle.

In the present invention, it is characteristic that NiO is contained in the glass material but not as an additive. Due to this, it is possible to bring a balance of the TCR and STOL of the resistor to be obtained with a smaller amount than that in the case of adding as an additive. A content of NiO in the glass material may be an amount of about 15% or smaller of that in the case of adding as an additive to the paste: preferably at least 0.1 mol %, more preferably at least 1 mol % and more preferably at least 2 mol %, and preferably 10 mol % or smaller, and more preferably 6 mol % or smaller.

Glass Material

The glass material substantially not including lead and including NiO is not particularly limited, but those including

an A group including at least one kind (preferably CaO) selected from CaO, SrO, BaO and MgO,

a B group including B₂O₃,

a C group including SiO₂, and

an E group including NiO are preferable.

More preferably, those including CaO, B₂O₃, SiO₂ and NiO are used as the glass material.

Contents of the respective groups are preferably

A group: 20 to 40 mol %,

B group: 18 to 45 mol %,

C group: 21 to 40 mol %, and

E group: 0.1 to 10 mol % (particularly 1 to 10 mol %); and more preferably

A group: 25 to 38 mol %,

B group: 20 to 40 mol %,

C group: 21 to 30 mol %, and

E group: 2 to 6 mol %.

Preferably, the glass material furthermore include a D group including at least one (preferably ZrO₂) of ZrO₂ and A1₂O₃ other than the A to C and E groups explained above. More preferably, those including CaO, B₂O₃, SiO₂, ZrO₂ and NiO are used as the glass material.

Contents of the respective groups in this case are

A group: 20 to 40 mol %,

B group: 18 to 45 mol %,

C group: 21 to 40 mol %,

D group: 10 mol % or smaller (note that 0 mol % is excluded) , and

E group: 0.1 to 10 mol % (particularly, 1 to 10 mol %);

and more preferably,

A group: 25 to 38 mol %,

B group: 20 to 40 mol %,

C group: 21 to 30 mol %,

D group: 1 to 5 mol %, and

E group: 2 to 6 mol %.

The glass material may furthermore include an F group including at least one kind selected from ZnO, MnO, CuO, CoO, Li₂O, Na₂O, K₂O, P₂O₅, TiO₂, Bi₂O₃, V₂O₅ and Fe₂O₃. A content of the F group in this case is preferably 0 to 5 mol % (note that 0 mol % is excluded), and more preferably 0 to 3 mol % (note that 0 mol % is excluded).

A content of the glass material in the paste is preferably 65 to 93 volume % (or 49 to 88 wt %), and more preferably 68 to 90 volume % (or 50 to 86 wt %).

Conductive Material

The conductive material substantially not including lead is not particularly limited and an Ag—Pd alloy, TaN, LaB₆, WC, MoSiO₂, TaSiO₂ and metals (Ag, Au, Pd, Pt, Cu, Ni, W and Mo, etc.), etc. may be mentioned in addition to ruthenium oxides. These substances may be used alone or in combination of two or more kinds. Among them, a ruthenium oxide is preferable. As the ruthenium oxide, ruthenium based pyrochlore (Bi₂Ru₂O₇₋ₓ, and Tl₂Ru₂O₇, etc.) and composite oxides of ruthenium (SrRuO₃, CaRuO₃ and BaRuO₃, etc.), etc. are also included other than ruthenium oxides (RuO₂, RuO₃ and RuO₄). Among them, ruthenium oxides and composite oxides of ruthenium are preferable, and RuO₂, SrRuO₃, CaRuO₃ and BaRuO₃, etc. are more preferable.

A content of the conductive material in the paste is preferably 7 to 35 volume %, and more preferably 8 to 30 volume %.

Organic Vehicle

An organic vehicle is obtained by dissolving a binder in an organic solvent. A binder used for the organic vehicle is not particularly limited and may be suitably selected from a variety of normal binders, such as ethyl cellulose and polyvinyl butyral. Also, the organic solvent to be used is not particularly limited and may be suitably selected from a variety of organic solvents, such as terpineol, butyl carbitol, acetone and toluene.

Additives

A resistor paste according to the present invention may include an additive in addition to the above components. As the additive, CuO, oxides having a perovskite type crystal structure (crystal structure expressed by ABX₃), ZnO and MgO, etc. may be mentioned.

CuO serves as a TCR adjuster. A content of CuO in this case is preferably 0.1 to 2 volume % (or 0.1 to 6 wt %), more preferably 0.5 to 2 volume % (or 0.5 to 6 wt %), and more preferably 1 to 3 volume % (or 1 to 4 wt %). When an adding quantity of CuO increases, the STOL is liable to decline.

As oxides having a perovskite type crystal structure, in addition to simple perovskite, such as CaTiO₃, SrTiO₃, BaTiO₃, CaZrO₃ and SrZrO₃, defective perovskite and multiple perovskite, etc. may be also mentioned. Among them, it is preferable to use at least one of CaTiO₃, SrTiO₃ and BaTiO₃, and it is more preferable to use CaTiO₃. Oxides having a perovskite type crystal structure give an effect of adjusting a balance of the TCR and STOL. A content of the oxides having a perovskite type crystal structure in this case is preferably 0.1 to 12 volume % (or 0.1 to 20 wt %), more preferably 1 to 15 volume % (or 1 to 17 wt %), and furthermore preferably 1.5 to 12 volume % (or 2 to 15 wt %).

ZnO serves as a TCR adjuster. A content of ZnO in this case is preferably 0.1 to 5 volume %, and more preferably 1 to 4 volume %. When an adding quantity of ZnO increases, the STOL is liable to decline.

MgO serves as a TCR adjuster. A content of MgO in this case is preferably 1 to 8 volume %, and more preferably 2 to 6 volume %. When an adding quantity of MgO increases, the STOL is liable to decline.

Note that as other additives serving as a TCR adjuster, for example, MnO₂, V₂O₅, TiO₂, Y₂O₃, Nb₂O₅, Cr₂O₃, Fe₂O₃, CoO, Al₂O₃, ZrO₂, SnO₂, HfO₂, WO₃ and Bi₂O₃, etc. may be mentioned.

Production Method of Paste

A resistor paste according to the present invention is produced by adding an organic vehicle to a conductive material, a glass material and a variety of additives to be compounded in accordance with need and kneading, for example, by a triple-roll mill. In this case, a ratio (W2/W1) of a total weight (W1) of powders of the glass material, conductive material and additives to be added in accordance with need to a weight (W2) of the organic vehicle is preferably 0.25 to 4, and more preferably 0.5 to 2.

Resistor and Electronic Device

A resistor according to the present invention includes a glass material substantially not including lead and including NiO and a conductive material substantially not including lead. A film thickness of the resistor may be thin, but it is normally as thick as 1 μm or thicker, and more preferably 10 to 15 μm or so.

A resistor according to the present invention is produced by forming the above resistor paste on a substrate formed, for example, by alumina, glass ceramic, dielectric or AlN, for example, by a screen printing method, etc., drying, and burning at 800to 900° C. or so for 5 to 15 minutes.

The resistor can be applied to an electrode part of a capacitor and an inductor, etc. in addition to a single-layer or multilayer circuit substrate as an electronic device.

### EXAMPLES

Next, more specific examples of the embodiment of the present invention will be given to explain the present invention further in detail. Note that the present invention is not limited only to the examples.

### Example 1

### Production of Resistor Paste

A conductive material was produced as below. Predetermined amounts of CaCO₃ or Ca(OH)₂ powder and RuO₂ powder were weighed to give a composition of CaRuO₃, mixed by a ball mill and dried. A temperature of the obtained powder was raised at a rate of 5° C./min. to 1200° C., the temperature was held for 5 hours and, then, cooled at a rate of 5° C./min. to the room temperature. The obtained CaRuO₃ compound was pulverized by a ball mill to obtain a CaRuO₃ powder. The obtained powder was confirmed by using an XRD that a desired compound in a single phase was obtained.

Also, other than the CaRuO₃ powder, a SrRuO₃ powder and a Bi₂Ru₂O₇ powder were obtained through the same procedure.

In the present example, a RuO₂ powder was prepared as a conductive material in addition to the CaRuO₃ powder, SrRuO₃ powder and Bi₂Ru₂O₇ powder.

A glass material was produced as below. Predetermined amounts of CaCO₃, SrCO₃, MgO, B₂O₃, SiO₂, ZrO₂, Al₂O₃ and NiO were weighed to give final compositions (18 kinds) shown in Table 1, mixed by a ball mill and dried. A temperature of the obtained powder was raised at a rate of 5° C./min. to 1300° C., the temperature was held for 1 hour and, then, rapidly quenched by dropping the powder into water for vitrifying. The obtained vitrification was pulverized by a ball mill to obtain a glass powder. The obtained glass powder was confirmed to be amorphous by using an XRD.

TABLE 1

| Glass Material | |
|---|---|
| No. | Composition (mol %) |
| *\textcircled{1} | CaO:B₂O₃:SiO₂:ZrO₂:NiO = 34:36:25:5:0 |
| \textcircled{2} | CaO:B₂O₃:SiO₂:ZrO₂:NiO = 33:34:24:4:5 |
| \textcircled{3} | CaO:B₂O₃:SiO₂:ZrO₂:NiO = 34:36:25:0:5 |
| \textcircled{4} | CaO:B₂O₃:SiO₂:ZrO₂:NiO = 34:30:21:10:5 |
| \textcircled{5} | CaO:B₂O₃:SiO₂:ZrO₂:NiO = 40:30:21:4:5 |
| \textcircled{6} | CaO:B₂O₃:SiO₂:ZrO₂:NiO = 33:18:40:4:5 |
| \textcircled{7} | CaO:B₂O₃:SiO₂:ZrO₂:NiO = 20:45:26:4:5 |
| \textcircled{8} | CaO:B₂O₃:SiO₂:ZrO₂:NiO = 34:35:25:4:2 |
| \textcircled{9} | CaO:B₂O₃:SiO₂:ZrO₂:NiO = 31:32:24:3:10 |
| *\textcircled{10} | CaO:B₂O₃:SiO₂:ZrO₂:NiO = 31:31:24:3:11 |
| \textcircled{11} | CaO:B₂O₃:SiO₂:ZrO₂:NiO = 34:36:25:4.9:0.1 |
| \textcircled{12} | CaO:B₂O₃:SiO₂:ZrO₂:NiO = 34:36:25:4:1 |
| *\textcircled{13} | CaO:B₂O₃:SiO₂:Al₂O₃:NiO = 34:36:25:5:0 |
| \textcircled{14} | CaO:B₂O₃:SiO₂:Al₂O₃:NiO = 33:34:24:4:5 |
| *\textcircled{15} | SrO:B₂O₃:SiO₂:ZrO₂:NiO = 34:36:25:5:0 |
| \textcircled{16} | SrO:B₂O₃:SiO₂:ZrO₂:NiO = 33:34:24:4:5 |
| *\textcircled{17} | CaO:MgO:B₂O₃:SiO₂:ZrO₂:NiO = 24:10:36:25:5:0 |
| \textcircled{18} | CaO:MgO:B₂O₃:SiO₂:ZrO₂:NiO = 23:10:34:24:4:5 |

An organic vehicle was produced as below. While heating and agitating terpineol as a solvent, ethyl cellulose as a resin was dissolved, so that an organic vehicle was produced.

Additives as shown in Table 2 were selected as the additives.

The produced conductive material powder, glass powder and the selected additives were weighed to give respective compositions shown in Table 2 (indicated both in volume % and wt %), the organic vehicle was added thereto and kneaded by a triple-roll mill, so that a resistor paste was obtained. A weight ratio of a total weight of powders of the conductive material, glass material and additives to the weight of organic vehicle was suitably adjusted in a range of 1:0.25 to 1:4 in the weight ratio so as to give a paste to be obtained suitable viscosity for screen printing, and the result was made to be a paste.

Production of Thick-Film Resistor

An Ag—Pt conductive paste was printed by screen printing to be in a predetermined shape on a 96% purity alumina substrate and dried. Ag was 95 wt % and Pt was 5 wt % in the Ag—Pt conductive paste. The alumina substrate was set in a belt furnace to burn a conductor on the substrate in a pattern of 1 hour from the input to output. The burning temperature was 850° C. and the holding time of the temperature was 10 minutes. On the alumina substrate with a conductor formed thereon, the resistor paste produced as explained above was printed by screen printing to be in a predetermined shape (1×1 mm) and dried. Then, the resistor paste was burnt under the same condition as that at burning the conductor and a thick-film resistor was obtained. A thickness of the resistor was 12 μm.

### Evaluation of Thick-Film Resistor

Characteristics (TCR and STOL)

An evaluation of TCR and STOL was made on the obtained thick-film resistor.

An evaluation of the TCR (temperature characteristic of resistance) was made by measuring a change rate of the resistance when changing a temperature to 125° C. based on that at the room temperature of 25° C. Specifically, by expressing resistances at 25° C., −55° C. and 125° C. as R₂₅, R₁₂₅ (Ω/□), the TCR was obtained from TCR=(R₂₅-R₁₂₅)/R₂₅/100×1000000 (the unit is ppm/° C.). The results are shown in Table 2. Normally, TCR<±400 ppm/° C. is a criterion of the characteristic.

An evaluation of the STOL (short-time overload) was made by applying a test voltage to the thick-film resistor for 5 seconds, then, leaving it stand for 30 minutes, and measuring a change rate of the resistance before and after that. The test voltage was 2.5 times as high as the rated voltage. The rated voltage was √ (R/8), wherein “R” is a resistance (Ω/□). Note that resistors exhibited a resistance, by which the calculated test voltage exceeded 200V, were evaluated with a test voltage of 200V. The results are shown in Table 2. Normally, STOL<±5% is a criterion of the characteristic.

Note that the number of samples used for each evaluation was 24.

TABLE 2

| | Conductive Material | | | Glass Material | | | Additive | | | | | |
|---|---|---|---|---|---|---|---|---|---|---|---|---|
| Sample | | Volume | | | Volume | | | Volume | | Sheet Resistance | TCR | STOL |
| No. | Type | % | wt % | Type | % | wt % | Type | % | wt % | Ω/□ | ppm/° C. | % |
| *1 | CaRuO₃ | 17 | 28.76 | \textcircled{1} | 83 | 71.24 | — | — | — | 158000 | −450 | −5.7 |
| *2 | CaRuO₃ | 6 | 10.66 | \textcircled{1} | 90 | 81.08 | CuO | 4 | 8.27 | 227000 | 200 | −63.4 |
| 3 | CaRuO₃ | 18 | 29.61 | \textcircled{2} | 82 | 70.39 | — | — | — | 134600 | −180 | −1.8 |
| 4 | CaRuO₃ | 18 | 30.51 | \textcircled{3} | 82 | 69.49 | — | — | — | 135500 | −350 | −3.3 |
| 5 | CaRuO₃ | 30 | 43.35 | \textcircled{4} | 70 | 56.65 | — | — | — | 100100 | −190 | −1.5 |
| 6 | CaRuO₃ | 15 | 24.82 | \textcircled{5} | 85 | 75.18 | — | — | — | 147500 | −200 | −2.5 |
| 7 | CaRuO₃ | 35 | 50.96 | \textcircled{6} | 65 | 49.04 | — | — | — | 109900 | 90 | −0.8 |
| 8 | CaRuO₃ | 20 | 33.25 | \textcircled{7} | 80 | 66.75 | — | — | — | 355000 | −250 | −3.7 |
| 9 | CaRuO₃ | 18 | 30.05 | \textcircled{8} | 82 | 69.95 | — | — | — | 149000 | −360 | −4.5 |
| 10 | CaRuO₃ | 12 | 20.33 | \textcircled{9} | 88 | 79.67 | — | — | — | 127000 | −90 | −4.9 |
| *10-1 | CaRuO₃ | 12 | 20.16 | \textcircled{10} | 88 | 79.84 | — | — | — | 144300 | −90 | −6.0 |
| 11 | CaRuO₃ | 6 | 10.77 | \textcircled{2} | 93 | 87.14 | CuO | 1 | 2.09 | 1196000 | −150 | −4.3 |
| 12 | CaRuO₃ | 8 | 13.37 | \textcircled{2} | 78 | 68.04 | CuO | 2 | 3.89 | 1208000 | −90 | −0.5 |
| | | | | | | | CaTiO₃ | 12 | 14.70 | | | |
| *13 | RuO₂ | 10 | 21.73 | \textcircled{1} | 90 | 78.27 | — | — | — | 127000 | −420 | −6.9 |
| 14 | RuO₂ | 10 | 21.25 | \textcircled{2} | 90 | 78.75 | — | — | — | 110800 | −200 | −2.5 |
| *15 | SrRuO₃ | 18 | 33.84 | \textcircled{1} | 82 | 66.16 | — | — | — | 204600 | −650 | −7.6 |
| 16 | SrRuO₃ | 18 | 33.21 | \textcircled{2} | 82 | 66.79 | — | — | — | 131300 | −220 | −3.2 |
| *17 | Bi₂Ru₂O₇ | 22 | 44.71 | \textcircled{1} | 78 | 55.29 | — | — | — | 231400 | −750 | −8.4 |
| 18 | Bi₂Ru₂O₇ | 22 | 44.02 | \textcircled{2} | 78 | 55.98 | — | — | — | 188400 | −350 | −4.1 |
| 19 | CaRuO₃ | 20 | 33.01 | \textcircled{11} | 80 | 66.99 | — | — | — | 231000 | −280 | −4.5 |
| 20 | CaRuO₃ | 20 | 33.01 | \textcircled{12} | 80 | 66.99 | — | — | — | 194200 | −260 | −3.8 |
| *21 | CaRuO₃ | 15 | 26.23 | \textcircled{13} | 85 | 73.77 | — | — | — | 119300 | −450 | −9.2 |
| 22 | CaRuO₃ | 15 | 25.61 | \textcircled{14} | 85 | 74.39 | — | — | — | 100700 | −170 | −4.8 |
| *23 | CaRuO₃ | 19 | 29.12 | \textcircled{15} | 81 | 70.88 | — | — | — | 155200 | −520 | −6.5 |
| 24 | CaRuO₃ | 19 | 28.67 | \textcircled{16} | 81 | 71.33 | — | — | — | 154100 | −230 | −2.8 |
| *25 | CaRuO₃ | 15 | 25.81 | \textcircled{17} | 85 | 74.19 | — | — | — | 121900 | −480 | −5.5 |
| 26 | CaRuO₃ | 15 | 25.27 | \textcircled{18} | 85 | 74.73 | — | — | — | 118700 | −80 | −0.7 |

*in Table indicates a comparative example.

As shown in Table 2, the cases of changing the glass composition (samples 1, 3 to 10-1, 19 to 26) lead to the understanding below.

The samples 1, 21, 23 and 25 including glass not added with NiO (E group) were confirmed to have a deteriorated TCR. On the other hand, the samples 3 to 10, 19, 20, 22, 24 and 26 including glass added with NiO in a range of 0.1 to 10 mol % were confirmed to be capable of suppressing the TCR and STOL small. Note that in the sample 10-1 including glass added with 11 mol % of NiO (E group), the STOL was liable to decline comparing with that in the samples 1, 21, 23 and 25 including glass not added with NiO, but it was in an acceptable range.

As to CaO (A group), when conducting the same experiment by replacing MgO, SrO and BaO belonging to the same II group, it was confirmed that the same tendency was observed (refer to the samples 23 to 26). When replacing ZrO₂ by Al₂O₃ (D group), it was confirmed that the same tendency was observed (refer to the samples 21 and 22).

Note that in the case of furthermore adding at least one kind selected from ZnO, MnO, CuO, CoO, Li₂O, Na₂O, K₂O, P₂O₅, TiO₂, Bi₂O₃, V₂O₅ and Fe₂O₃, it was confirmed that the same tendency was observed.

Note that it was confirmed that the same tendency was observed even when a kind of the conductive material was changed (the samples 13 to 18).

The cases added with an additive (the samples 2, 11 and 12) lead to the understanding below. In the sample 2 including glass added with CuO as an additive but not added with NiO, the STOL was confirmed to be deteriorated. It is considered that the STOL deteriorated because NiO was not added, so that deterioration of the STOL due to adding of CuO was not be able to be suppressed. On the other hand, the sample 11 including glass added with 5 mol % of NiO exhibited an effect of improving the TCR and STOL. In the sample 12 added with CaTiO₃ together with CuO as additives, an effect of furthermore improving the TCR and STOL was confirmed.

### Example 2

Predetermined amounts of CaCO₃, B₂O₃, SiO₂ and ZrO₂ were prepared and blended to satisfy CaO:B₂O₃:SiO₂:ZrO₂=34 mol %: 36 mol %: 25 mol %: 5 mol % so as to obtain a glass powder in the same way as that in the example 1.

The obtained glass powder, the conductive material of the example 1 and NiO as an additive were weighed to obtain 28 volume % of the conductive material (CaRuO₃), 60 volume % of the glass powder and 12 volume % of NiO, added with an organic vehicle and kneaded by a triple-roll mill, so that the same resistor paste (the sample 27) as that in the example 1 was obtained.

By using the obtained resistor paste, a thick-film resistor was obtained in the same way as that in the example 1. When measuring a NiO content in the resistor, it was 19.8 wt %. The TCR and STOL were evaluated on the obtained thick-film resistor in the same way as that in the example 1. As a result, preferable results of the resistance of 110100 Ω, the TCR of 90 ppm/° C. and the STOL of −0.8% were obtained.

On the other hand, the sample 7 in Table 2 explained above indicates an example of using a glass material including 5 mol % of NiO. When calculating a NiO content in the thick-film resistor obtained by using the resistor paste of the sample 7, it was 2.9 wt %. However, in the sample 7, an almost equivalent evaluation as that in the sample 27 was obtained.

From the above, an effect of improving the TCR and STOL can be obtained even when adding NiO as an additive, however, a larger amount of NiO has to be added comparing with that in the case of the sample 7, wherein NiO is included in the glass material.

On the other hand, it was learnt that when NiO was contained in the glass material, even if the NiO content in the resistor was small, an equivalent result to that in the case of including NiO as an additive could be obtained, and the productivity could be improved.

The embodiment of the present invention was explained above, but the present invention is not limited to the embodiment and may be variously modified within the scope of the present invention.

1. A resistor paste comprising a glass material substantially not including lead and including NiO, a conductive material substantially not including lead, and an organic vehicle.

2. A resistor paste comprising a glass material substantially not including lead and including 0.1 to 10 mol % of NiO, a conductive material substantially not including lead, and an organic vehicle.

3. The resistor paste as set forth in claim 1, wherein a content of said glass material is 65 to 93 volume % and a content of said conductive material is 7 to 35 volume %.

4. The resistor paste as set forth in claim 1, wherein a content of said glass material is 49 to 88 wt % and a content of said conductive material is 10 to 51 wt %.

5. The resistor paste as set forth in claim 1, wherein said glass material includes
an A group including at least one kind selected from CaO, SrO, BaO and MgO,
a B group including B₂O₃,
a C group including SiO₂,
a D group including at least one of ZrO₂ and Al₂O₃, and
an E group including NiO.

6. The resistor paste as set forth in claim 5, wherein contents of the respective groups are
A group: 20 to 40 mol %,
B group: 18 to 45 mol %,
C group: 21 to 40 mol %,
D group: 10 mol % or smaller (note that 0 mol % is excluded), and
E group: 0.1 to 10 mol %.

7. The resistor paste as set forth in claim 1, wherein said glass material includes
an A group including at least one kind selected from CaO, SrO, BaO and MgO,
a B group including B₂O₃,
a C group including SiO₂, and
an E group including NiO.

8. The resistor paste as set forth in claim 7, wherein contents of the respective groups are
A group: 20 to 40 mol %,
B group: 18 to 45 mol %,
C group: 21 to 40 mol %, and
E group: 0.1 to 10 mol %.

9. The resistor paste as set forth in claim 1, including CuO as an additive, wherein a content of the CuO is 0.1 to 2 volume %.

10. The resistor paste as set forth in claim 1, including CuO as an additive, wherein a content of the CuO is 0.1 to 6 wt %.

11. The resistor paste as set forth in claim 1, including an oxide having a perovskite type crystal structure as an additive, wherein a content of the oxide is 0.1 to 12 volume %.

12. The resistor paste as set forth in claim 1, including an oxide having a perovskite type crystal structure as an additive, wherein a content of the oxide is 0.1 to 20 wt %.

13. The resistor paste as set forth in claim 11, wherein the oxide having a perovskite type crystal structure is CaTiO₃.

14. A resistor including a glass material substantially not including lead and including NiO and a conductive material substantially not including lead.

15. An electronic device comprising a resistor, wherein said resistor includes a glass material substantially not including lead and including NiO and a conductive material substantially not including lead.
